(19) United States
(12) Patent Application Publication
(10) Pub. No.: US 2019/0106590 A1
(43) Pub. Date: Apr. 11, 2019

(54) COATING COMPOSITION CONTAINING A SORBIC ACID ESTER AND A PHOTOCATALYST

(71) Applicants: Dow Global Technologies LLC, Midland, MI (US); Rohm and Haas Company, Collegeville, PA (US)

(72) Inventors: Selvanathan Arumugam, Blue Bell, PA (US); John Ell, Midland, MI (US); Yan Li, Shanghai (CN); Bo Lv, Shanghai (CN); Brandon Rowe, Robbinsville, NJ (US); Yu Zhang, Carmel, IN (US); Jiquang Zhang, Shanghai (CN)

(73) Assignees: Dow Global Technologies LLC, Midland, MI (US); Rohm and Haas Company, Collegeville, PA (US)

(21) Appl. No.: 16/089,446

(22) PCT Filed: Apr. 8, 2016
(86) PCT No.: PCT/CN2016/078776

§ 371 Date: Sep. 28, 2018

(51) Int. Cl. C09D 125/14; C09D 123/08; C09D 133/08; C09D 5/02

(52) U.S. Cl. CPC C09D 125/14; C09D 123/0846; C08F 265/06; C09D 5/024; C09D 133/08

(57) ABSTRACT

Provided is a composition comprising a) a stable aqueous dispersion of polymer particles, b) a sorbic acid ester, c) a photocatalyst and d) a free radical precursor. The composition provides a way to increase Koenig hardness of a coating rapidly and with reduced yellowing.

The present invention relates to a composition comprising a sorbic acid ester and a photocatalyst. The composition provides a way to accelerate the curing of sorbic acid esters in coating compositions with concomitant reduction of yellowing.

Recent environmental regulations around the globe are driving the need in the architectural coatings market for materials with very low or no odor and low volatile organic chemicals (VOCs). Balancing VOCs against desired paint performance attributes is a continuing challenge.

Paint formulations comprise either a low T_{g} polymer latex that forms film with little or no coalescent, or a high T_{g} latex that forms film with the aid of a coalescent. Formulations containing low T_{g} polymers generally give coatings having a soft and tacky feel and poor durability. Formulations using high-T_{g} polymers, on the other hand, require either permanent (nonvolatile) coalescents or volatile coalescents; permanent coalescents are known to adversely affect the hardness performance of the consequent coating; volatile coalescents such as Texanol, on the other hand, may give acceptable hardness performance—for example, a König hardness of ˜20 s at 28 days for a typical semigloss paint—but are undesirable for their volatility.

Both low temperature film formation and film hardness can be achieved by using a reactive coalescent. For example, WO 2007/094922 describes the use of a bis-allylic unsaturated fatty acid ester as a reactive coalescent. Unfortunately, the described coalescent does not yield the desired hardness performance properties for the consequent coating.

A particularly attractive class of coalescents is the sorbic acid ester (sorbate), especially the disorbate ester, which has a particularly low VOC. An ongoing concern with sorbates is the relatively long time required to achieve maximum film hardness (˜28 days) of the coated film.

It would therefore be an advantage in the art of low VOC coalescents to discover a way to accelerate the rate of cure of coatings containing sorbate coalescents without significantly adversely impacting other properties in the coating.

### SUMMARY OF THE INVENTION

The present invention addresses a need in the art by providing a composition comprising a) a stable aqueous dispersion of polymer particles, b) a sorbic acid ester, c) a photocatalyst that is capable of generating free radicals by way of a redox process and having an excited state redox potential in the range of from less than −0.2 V to not less than −2.5 V, and d) a free radical precursor having a ground state redox potential in the range of from 0.5 V to −2 V, with the proviso that the ground state potential of the free radical precursor is greater than the excited state redox potential of the photocatalyst. The composition provides a way to increase Koenig hardness of a coating rapidly and with reduced yellowing.

### DETAILED DESCRIPTION OF THE INVENTION

The present invention addresses a need in the art by providing a composition comprising a) a stable aqueous dispersion of polymer particles, b) a sorbic acid ester, c) a photocatalyst that is capable of generating free radicals by way of a redox process and having an excited state redox potential in the range of from less than −0.2 V to not less than −2.5 V, and d) a free radical precursor having a ground state redox potential in the range of from 0.5 V to −2 V, with the proviso that the ground state potential of the free radical precursor is greater than the excited state redox potential of the photocatalyst.

The sorbic acid ester, also known as a sorbate or a sorbate ester, preferably is a liquid at 20° C. and preferably has a boiling point above 250° C. Examples of suitable sorbic acid esters, include:

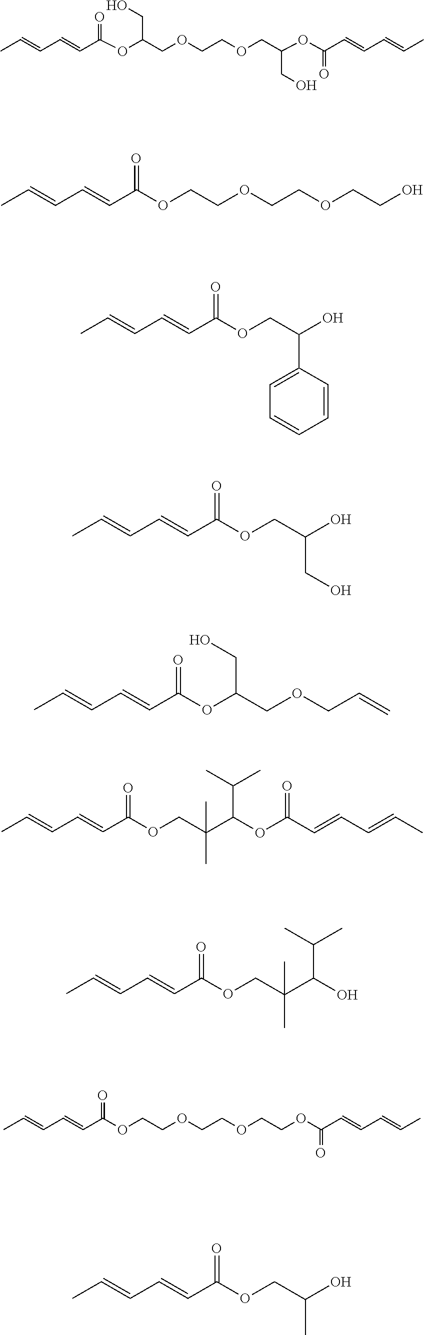

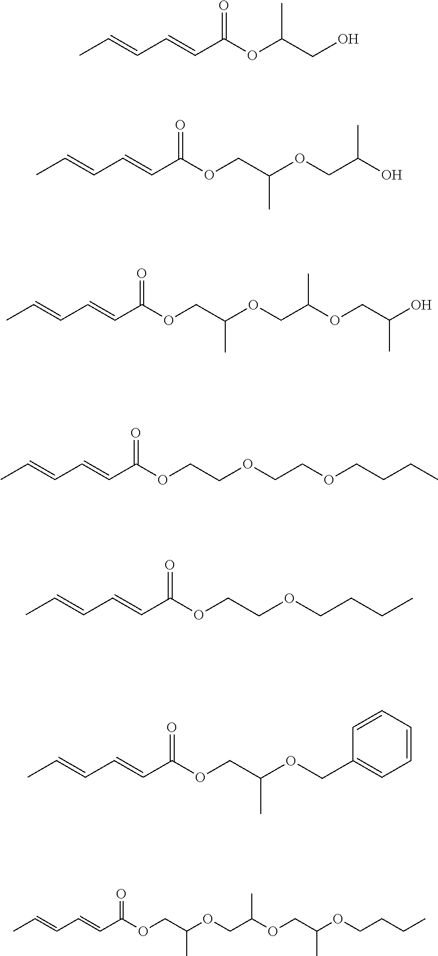

Preferred sorbic acid esters are triethylene glycol disorbate and propylene glycol monosorbate (two isomers), as illustrated:

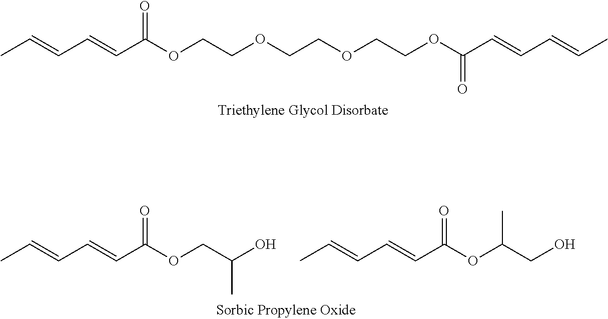

Sorbic acid esters can be prepared in a variety of ways, such as those described in WO2015/157929 A1.

The photocatalyst (P) is capable of generating free radicals by way of a redox process; furthermore, the photocatalyst has an excited state redox potential (E_{1/2} [P⁺/P*]) of less than −0.2 V and not less than −2.5 V. Excited state reduction potential are calculated from ground state redox potential (measured by cyclic voltammetry) and the energy gap between the zero^{th} vibrational levels of the ground and excited states (determined from the 0-0 vibrational transition in the fluorescence spectrum of the lowest-lying singlet state) using Rehm and Weller equation. (See Wayne E. Jones, Jr., and Marye Anne Fox J. Phys. Chem. 1994, 98, 5095-5099). Examples of suitable classes of photocatalysts include perylenes and N-alkyl and N-aryl phenothiazines. Preferably, the photocatalyst is N-phenyl phenothiazine, an N—C₁-C₆-alkyl phenothiazine such as N-methyl phenothiazine, perylene, or a perylene derivative characterized by either of the following formulas:

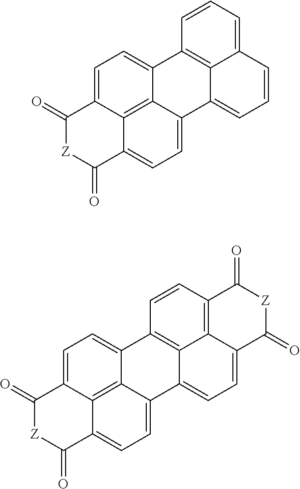

where Z is O, NH, or N-methyl.

All redox potentials reported herein are referenced against the standard hydrogen electrode (SHE). The photocatalyst is preferably used at a concentration in the range of from 0.02, more preferably from 0.05, and most preferably from 0.1 weight percent, to 1, more preferably to 0.5, and most preferably to 0.3 weight percent, based on the weight of the sorbic acid ester.

The free radical precursor has a ground state redox potential in the range of from 0.5 V to −2 V), with the proviso that the ground state potential of the free radical precursor is greater than the excited state redox potential of the photocatalyst. Examples of classes of suitable free radical precursors include compounds having a carbon-halogen bond, a nitrogen-halogen bond, a sulfur-halogen bond, and oxygen-halogen bond, a thiocyanate group, or a thiocarbamate group. Preferred classes of free radical precursors are α-halocarbonyl compounds, α-halobenzyl compounds, or iodonium salts. Preferred examples of free radical precursors are diphenyl iodonium hexafluorophosphate or methyl-α-bromophenylacetate:

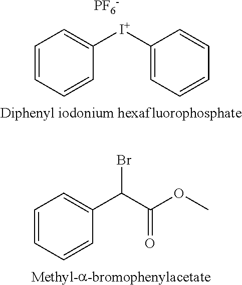

The free radical precursors are preferably used in the range of from 0.1, more preferably from 0.2, and most preferably from 0.5 weight percent, to 10, more preferably to 5, and most preferably to 2 weight percent, based on the weight of the sorbic acid ester.

The composition also includes a stable aqueous dispersion of polymer particles (a latex). Suitable latexes include stable aqueous dispersions of acrylic, styrene-acrylic, vinyl ester-acrylic, alkyd, and vinyl ester-polyethylene latexes. The solids content of the latex is preferably in the range of 30 to 60%, and the polymer particles are preferably not film-forming at ambient temperatures.

The composition of the present invention also advantageously includes one or more of the following components: pigments such as TiO₂; rheology modifiers; opaque polymers; colorants; fillers; dispersants; wetting aids; anti-oxidants; surfactants; co-solvents; additional coalescents; defoamers; preservatives; flow agents; leveling agents; slip additives; and neutralizing agents.

The composition of the present invention provides a way to cure coatings faster with less yellowing, as the following examples show.

### EXAMPLES

For the examples of the present invention perylene (calculated excited state potential of −1.8 V, 30 ppm based on the weight of the paint) and a free radical precursor (150 ppm based on the weight of the paint) were added to coating compositions containing either propylene glycol monosorbate (Sorbic PO) or triethylene glycol disorbate (TEG Disorbate). The components of the paint formulation are shown in Table 1.

TABLE 1
Master Gloss paint formulation

| Stage | Materials | Wt (g) |
|---|---|---|
| Grind | TiPure R-746 TiO₂ | 452.8 |
| | Water | 30 |
| | BYK-024 Defoamer | 3 |
| | TRITON ™ X-100 Surfactant | 6.6 |
| | TAMOL ™ 2002 Dispersant | 3 |
| | ACRYSOL ™ RM-2020 NPR Thickener | 30 |
| | Grind Sub-total | 644.41 |
| Let-down | RHOPLEX ™ HG-95P Emulsion Polymer | 882.7 |
| | BYK-024 Defoamer | 1.5 |
| | Ammonia (28%) | 0.38 |
| | ACRYSOL ™ RM-2020 NPR Thickener | 35.8 |
| | ACRYSOL ™ RM-8W Thickener | 2.67 |
| | Water | 137.06 |
| | Total | 4162.2 |

TRITON, TAMOL, ACRYSOL, AND RHOPLEX are Trademarks of The Dow Chemical Company or Its Affiliates.

The comparative examples contained sorbic acid esters but neither the photocatalyst nor the free radical precursor. Methyl α-bromophenylacetate (−1.0 V ground state redox potential, as reported in Helv. Chim. Acta, 1990, 73, 2225-2241) was used as the radical precursor for Example 1, and diphenyl iodonium hexafluorophosphate (0.4 V ground state redox potential, as reported in Polym. Chem., 2011, 2, 1185-1189) was used as the radical precursor for Example 2.

Koenig hardness measurements were completed according to ASTM D4366 method using a TQC Pendulum Hardness Tester, Model SP0500. The coatings used for Koenig measurements were made on Al substrates with a 10 mil blade gap.

Color was measured on white Leneta charts as the substrate using a BYK-Gardner color-guide sphere spectrophotometer. The color parameter that is of most interest for this work is the b* value from the CIE L*a*b* color spectrum. The b* value represents the balance between blue and yellow, with larger positive numbers indicating more yellowing. A rule of thumb suggests that a color difference with a Δb*>0.5 is visible to the naked eye. The results for Koenig hardness are shown in Table 2.

TABLE 2
Koenig Hardness for Coatings with and without
Photocatalyst/Radical Precursor

| | | Photocatalyst + | Koenig | | | |
|---|---|---|---|---|---|---|
| | | Radical | hardness (s) | | | |
| Example | Coalescent | Precursor? | 1 d | 7 d | 9 d | 23 d |
| Example 1 | Sorbic PO | Yes | 14 | 35 | 41 | 41 |
| Comp. 1 | Sorbic PO | No | 9 | 19 | 19 | 28 |
| Example 2 | TEG Disorbate | Yes | 21.7 | 41.7 | 45 | 48.7 |
| Comp. 2 | TEG Disorbate | No | 17 | 19.3 | 19.3 | 23.3 |

The results show that Koenig hardness is increased significantly and maximum hardness is achieved considerably faster for samples containing the photocatalyst and the radical precursor.

The degree of yellowing of the cured coating was also measured for the compositions, as illustrated in Table 3.

TABLE 3
Degree of Yellowing of Cured Coatings

| | | Photocatalyst + | Yellowing | | | |
|---|---|---|---|---|---|---|
| | | Radical | (b*) | | | |
| Experiment | Coalescent | Precursor? | 1 d | 7 d | 9 d | 23 d |
| Example 1 | Sorbic PO | Yes | 2.1 | 2.5 | 2.3 | 2.8 |
| Comp. 1 | Sorbic PO | No | 3.2 | 5.0 | 5.6 | 6.8 |
| Example 2 | TEG Disorbate | Yes | 1.0 | 2.9 | 2.9 | 3.1 |
| Comp. 2 | TEG Disorbate | No | 4.1 | 6.8 | 7.2 | 7.1 |

For the samples containing photocatalyst and radical precursor, the degree of yellowing does not increase significantly beyond what is observed after the first day the coating is applied to the substrate. Even after 23 days, the extent of yellowing observed for examples of the present invention is considerably less than what is measured for the comparative examples (2.8 vs. 6.8, and 3.1 vs. 7.1); moreover, it is less pronounced that what is observed after 1 day for the comparative examples (2.8 vs 3.2, and 3.1 vs 4.1).

1. A composition comprising a) a stable aqueous dispersion of polymer particles, b) a sorbic acid ester, c) a photocatalyst that is capable of generating free radicals by way of a redox process and having an excited state redox potential in the range of from less than −0.2 V to not less than −2.5 V, and d) a free radical precursor having a ground state redox potential in the range of from 0.5 V to −2 V, with the proviso that the ground state potential of the free radical precursor is greater than the excited state redox potential of the photocatalyst.

2. The composition of claim 1 wherein the stable aqueous dispersion of polymer particles is an acrylic, a styrene-acrylic, a vinyl ester-acrylic, an alkyd, or a vinyl ester-polyethylene latex; wherein the sorbic acid ester is selected from the group consisting of:

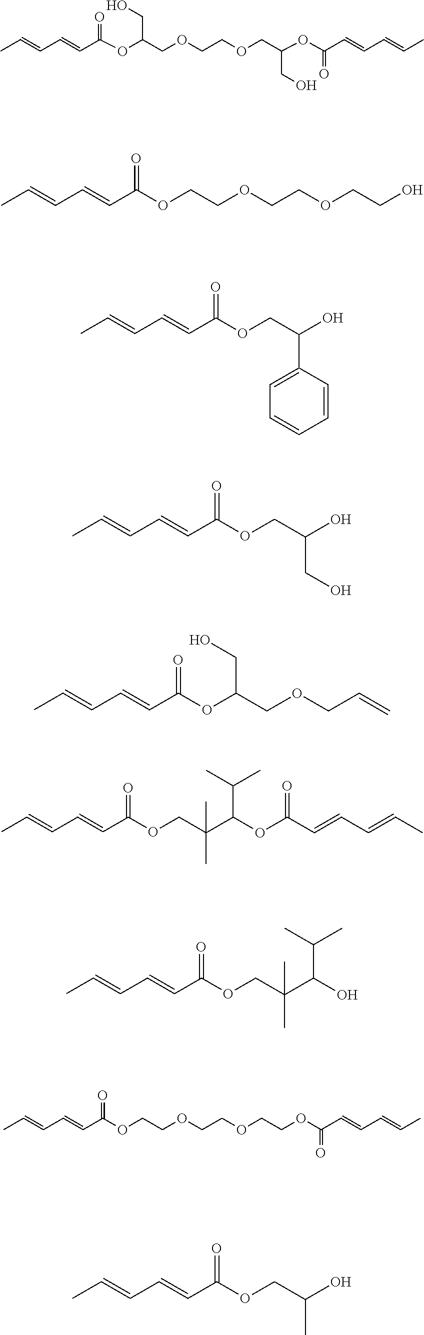

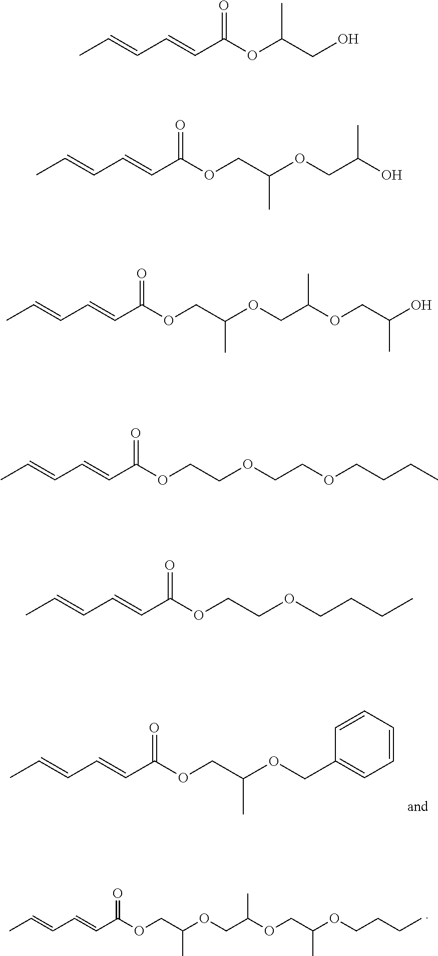

3. The composition of claim 2 wherein the photocatalyst is a perylene, an N—C₁-C₆-alkyl phenothiazine, or an N-aryl phenothiazine; and the free radical precursor is a compound having a carbon-halogen bond, a nitrogen-halogen bond, a sulfur-halogen bond, and oxygen-halogen bond, a thiocyanate group, or a thiocarbamate group.

4. The composition of claim 3 wherein the photocatalyst is perylene, N-methyl phenothiazine, N-phenyl phenothiazine, or a compound of either of the following formulas: 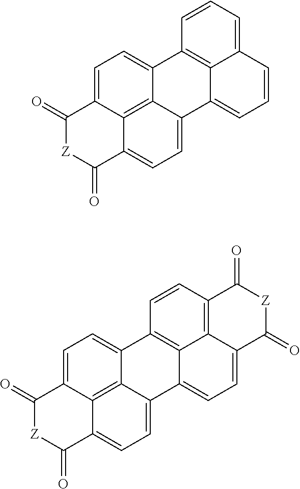
where Z is O, NH, or N-methyl; and
wherein the free radical precursor is iodonium hexafluorophosphate or methyl-α-bromophenylacetate.

5. The composition of claim 4 wherein the concentration of the photocatalyst is in the range of from 0.02 to 1 weight percent based on the weight of the sorbic acid ester; wherein the concentration of the free radical precursor is in the range of from 0.1 to 10 weight percent based on the weight of the sorbic acid ester.

6. The composition of claim 5 wherein the stable aqueous dispersion of polymer particles is an acrylic or styrene-acrylic latex, the concentration of the photocatalyst is in the range of from 0.1 to 0.5 weight percent based on the weight of the sorbic acid ester; wherein the concentration of the free radical precursor is in the range of from 0.5 to 2 weight percent based on the weight of the sorbic acid ester; and wherein the sorbic acid ester is propylene glycol monosorbate or triethylene glycol disorbate.

7. A composition comprising:
a) a stable aqueous dispersion of polymer particles,
b) a sorbic acid ester,
c) a photocatalyst selected from the group consisting of N-phenyl phenothiazine, N-methyl phenothiazine, perylene, and a perylene derivative characterized by the following formulas: 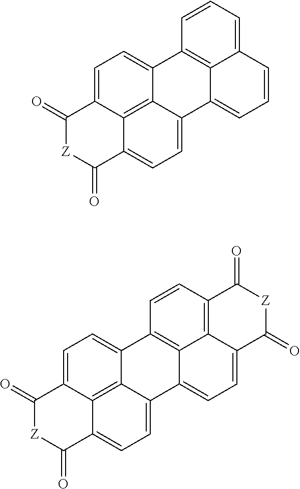
where Z is O, NH, or N-methyl, and
d) a free radical precursor which is iodonium hexafluorophosphate or methyl-α-bromophenylacetate.

8. The composition of claim 7 wherein the sorbic acid ester is propylene glycol monosorbate or triethylene glycol disorbate; wherein the concentration of the photocatalyst is in the range of from 0.1 to 0.5 weight percent based on the weight of the sorbic acid ester; wherein the photocatalyst is N-phenyl phenothiazine, N-methyl phenothiazine, or perylene; and wherein the concentration of the free radical precursor is in the range of from 0.5 to 2 weight percent based on the weight of the sorbic acid ester.
